(19) United States
(12) Patent Application Publication
(10) Pub. No.: US 2011/0106697 A1
(43) Pub. Date: May 5, 2011

(54) TRANSACTION PRODUCT ASSEMBLY WITH REMOTE CONTROLLED ARTICLE

(75) Inventors: Anthony V. Roberts, Rolling Hills Estates, CA (US); Timothy P. Clegg, Manhatten Beach, CA (US); Timothy D. Schumann, Arden Hills, MN (US)

(73) Assignee: TARGET BRANDS, INC., MINNEAPOLIS, MN (US)

(21) Appl. No.: 12/915,948

(22) Filed: Oct. 29, 2010

Related U.S. Application Data
(60) Provisional application No. 61/256,979, filed on Oct. 31, 2009.

(51) Int. Cl. G06K 19/00; G06Q 40/00; G06K 19/06; G06K 19/07

(52) U.S. Cl. 705/41; 235/494; 235/493; 235/492; 235/487

(57) ABSTRACT

A transaction product assembly includes a transaction product and a mechanical article. The transaction product includes an account identifier fixedly connected thereto, wherein the account identifier links the transaction product to an account and is machine readable by a terminal. The transaction product also includes a transmitting electrical assembly and at least one control button configured to interact with the transmitting electrical assembly in a manner causing the transmitting electrical assembly to output a radio frequency signal. The mechanical article includes at least one movable member, a receiving electrical assembly, and a motor. The receiving electrical assembly is configured to remotely receive the radio frequency signal output from the transmitting electrical assembly and to activate the motor. When activated, the motor induces movement of the at least one movable member relative to a remainder of the mechanical article in a manner consistent with the radio frequency signal.

### CROSS-REFERENCE TO RELATED APPLICATION

This non-provisional application claims the benefit under 35 U.S.C. §119(e) to U.S. Provisional Application No. 61/256,979, filed Oct. 31, 2009, which is incorporated herein in its entirety.

### BACKGROUND OF THE INVENTION

Stored-value cards and other transaction products come in many forms. A gift card, for example, is a type of transaction product that includes a pre-loaded or selectively loaded monetary value. In one example, a consumer buys a gift card having a specified value for presentation as a gift to another person. In another example, a consumer is offered a gift card as an incentive to make a purchase. A gift card, like other transaction cards, can be “recharged” or “reloaded” at the direction of the bearer. The balance associated with the gift card declines as the gift card is used, encouraging repeat visits to the retailer or other provider issuing the gift card. Additionally, the gift card generally remains in the user's purse or wallet, serving as an advertisement or reminder to revisit the associated retailer. Gift cards and other transaction cards provide a number of advantages to both the consumer and the retailer.

### SUMMARY OF THE INVENTION

One aspect of the present invention relates to a transaction product assembly including a transaction product and a mechanical article. The transaction product includes an account identifier fixedly connected thereto, wherein the account identifier links the transaction product to an account and is machine readable by a terminal. The transaction product also includes a transmitting electrical assembly, which is configured to output a radio frequency signal, and at least one control button configured to interact with the transmitting electrical assembly in a manner causing the transmitting electrical assembly to output the radio frequency signal. The mechanical article includes at least one movable member, a receiving electrical assembly, and a motor. The receiving electrical assembly is configured to remotely receive the radio frequency signal output from the transmitting electrical assembly and to activate the motor. When activated, the motor induces movement of the at least one movable member relative to a remainder of the mechanical article in a manner consistent with the radio frequency signal. Stored-value products, methods of providing a transaction product, and other embodiments of stored-value or transaction cards and associated combinations are also disclosed.

### BRIEF DESCRIPTION OF THE DRAWINGS

Embodiments of the invention will be described with respect to the figures, in which like reference numerals denote like elements, and in which:

FIG. 1 is a front view illustration of a transaction product assembly, according to one embodiment of the present invention.

FIG. 2 is a rear view illustration of the transaction product assembly of FIG. 1, according to one embodiment of the present invention.

FIG. 3 is a top view illustration of two transaction product assemblies including the transaction product assembly of FIG. 1, according to one embodiment of the present invention.

FIG. 4 is a perspective view illustration of a transaction product of the transaction product assembly of FIG. 1, according to one embodiment of the present invention.

FIG. 5 is a front view illustration of the transaction product of FIG. 4, according to one embodiment of the present invention.

FIG. 6 is a rear view illustration of the transaction product of FIG. 4, according to one embodiment of the present invention.

FIG. 7 is top view illustration of the transaction product of FIG. 4, according to one embodiment of the present invention.

FIG. 8 is a bottom view illustration of the transaction product of FIG. 4, according to one embodiment of the present invention.

FIG. 9 is a right side view illustration of the transaction product of FIG. 4, according to one embodiment of the present invention.

FIG. 10 is a left side view illustration of the transaction product of FIG. 4, according to one embodiment of the present invention.

FIG. 11 is an exploded, top perspective view illustration of the transaction product of FIG. 4, according to one embodiment of the present invention.

FIG. 12 is an exploded, bottom perspective view illustration of the transaction product of FIG. 4, according to one embodiment of the present invention.

FIG. 13 is a perspective view illustration of a remote controlled auxiliary vehicle of the transaction product of FIG. 1, according to one embodiment of the present invention.

FIG. 14 is an exploded, perspective view illustration of the remote controlled auxiliary vehicle of the transaction product of FIG. 1, according to one embodiment of the present invention.

FIG. 15 in a perspective view illustration of a portion of the remote controlled auxiliary vehicle of FIG. 13, according to one embodiment of the present invention.

FIG. 16 is a schematic illustration of non-transactional use of the transaction product assembly of FIG. 1, according to one embodiment of the present invention.

FIG. 17 is a flow chart illustrating a method of assembling a transaction product assembly, according to one embodiment of the present invention.

FIG. 18 is a flow chart illustrating a method of encouraging purchase and facilitating use of a transaction product assembly, according to one embodiment of the present invention.

FIG. 19 is a flow chart illustrating a method of using a transaction product assembly, according to one embodiment of the present invention.

### DESCRIPTION

The following detailed description of the invention provides examples and is not intended to limit the invention or the application and uses of the invention. Furthermore, there is no intention to be bound by any theory presented in the preceding background of the invention or the following detailed description of the invention.

A stored-value product assembly or other transaction product assembly is adapted to facilitate making purchases of goods and/or services at, for example, a retail store or website. According to one embodiment, an original consumer buys a transaction product assembly to give a recipient who in turn is able to use it to pay for goods and/or services. A transaction product assembly, according to embodiments of the present invention, provides the consumer and recipient with extra amusement and functionality in addition to the ability to pay for goods and/or services with the associated transaction product.

In particular, according to one embodiment, the transaction product assembly includes a transaction product and a remote controlled manufactured article, such as an auxiliary vehicle. In one embodiment, transaction product assembly is packaged for retail sale in a manner separately enclosing each of the transaction product and the remote controlled auxiliary vehicle. The transaction product is configured to function as a remote control transmitter to control the mechanical movements of the remote controlled auxiliary vehicle. In one embodiment, the transaction product includes a retractable antenna, control buttons (e.g., control forward, reward, and turning motions of the article), and/or an on/off switch for use in non-transaction interface with the remote controlled auxiliary vehicle. In one embodiment, the transaction product includes a chamber for receiving standard sized batteries with a slidable door providing access to the chamber.

In one embodiment, the auxiliary vehicle includes wheels for moving along a support surface, steering members, and a drive assembly, wherein at least the drive assembly is configured to receive control instructions from transaction product and to effectuate corresponding movement of the auxiliary vehicle. The auxiliary vehicle includes batteries, and in one embodiment, an on/off switch. Other types of article movement and/or control are also contemplated.

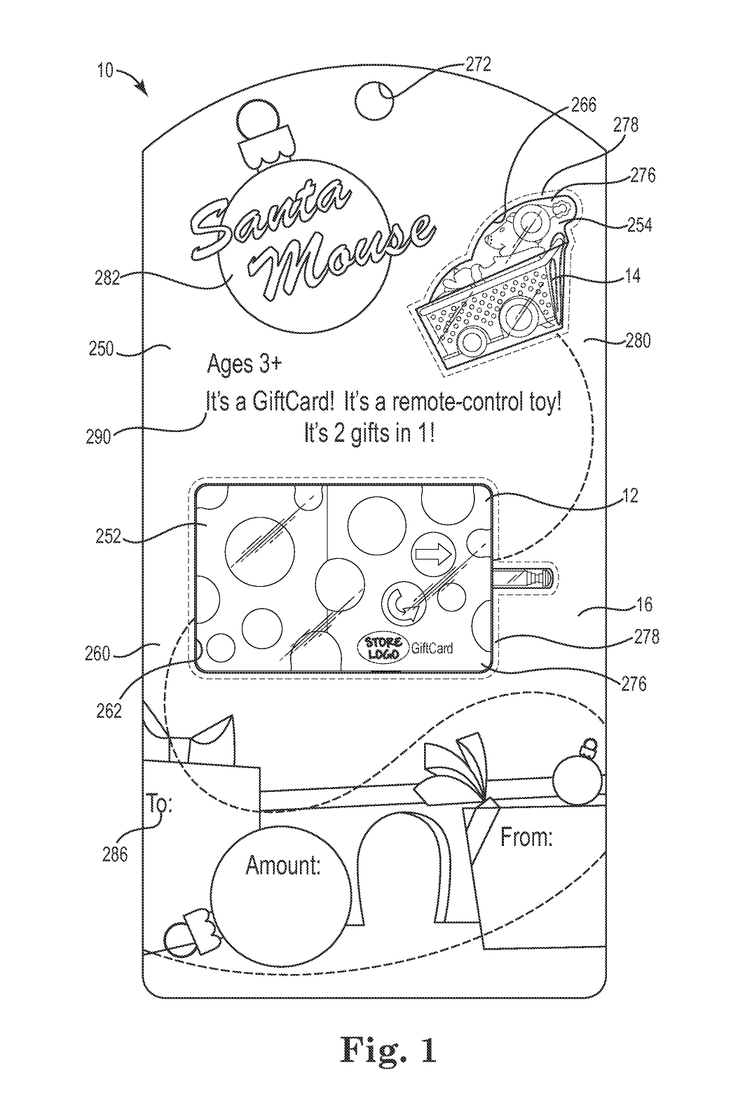

Turning to the figures, FIGS. 1-3 illustrate various views of one embodiment of a transaction product assembly 10 including a transmitter or transaction product 12, a mechanical article or auxiliary vehicle 14, and a package 16. Transaction product 12 facilitates purchase of retail items and/or is configured to be applied toward use of pre-stored calling minutes, etc. and may be in the form of a card (e.g., gift card, calling card, credit card, or debit card) or may take any other suitable form. In one embodiment, transaction product 12 is also configured for use as a remote for controlling movement of auxiliary vehicle 14 in an amusing or other non-transactional manner. Auxiliary vehicle 14 is any item having at least one moveable member (e.g., a wheel) configured to move upon actuation of the item induced, for example, due to radio frequency or similar communication from transaction product 12. Package 16 is configured to substantially enclose transaction product 12 and auxiliary vehicle 14 for transport and presentation in a retail store or related setting.

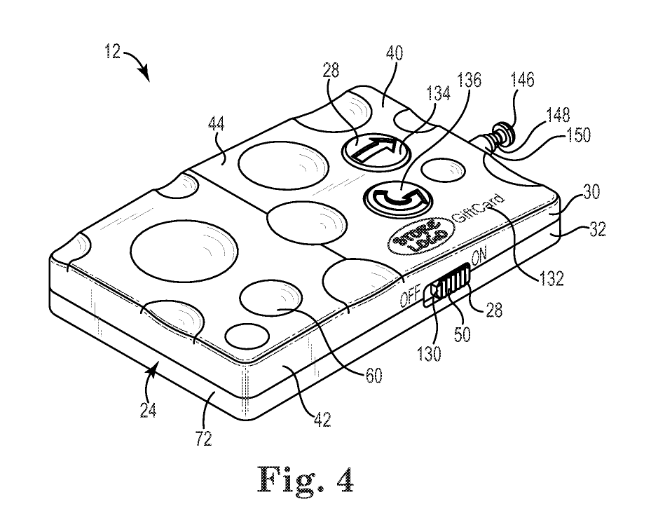

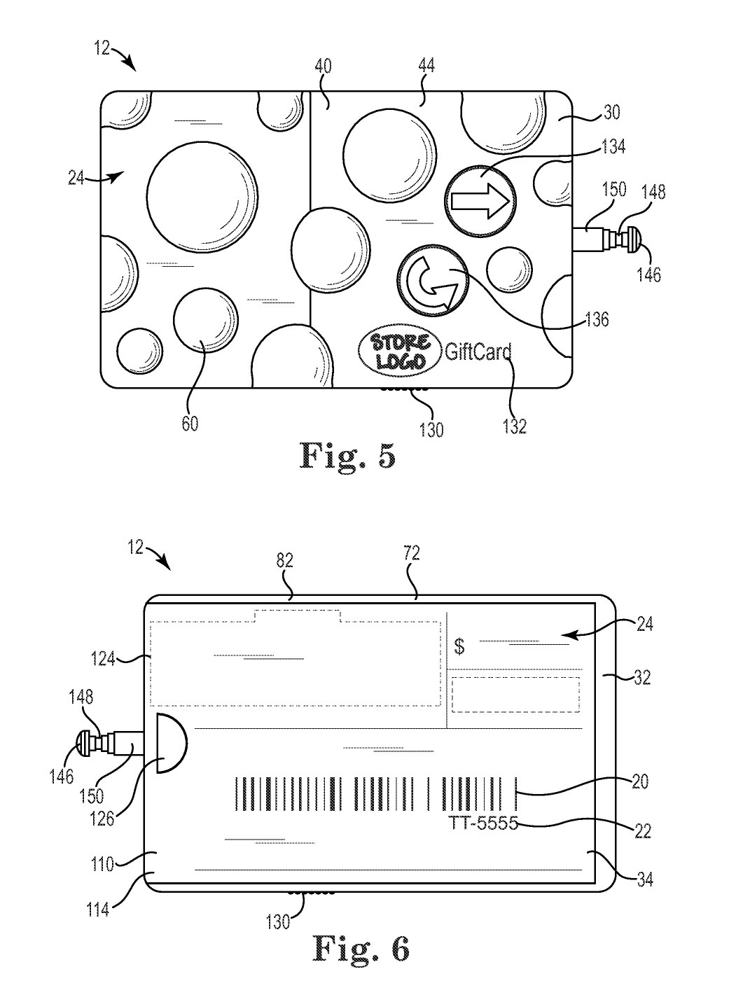

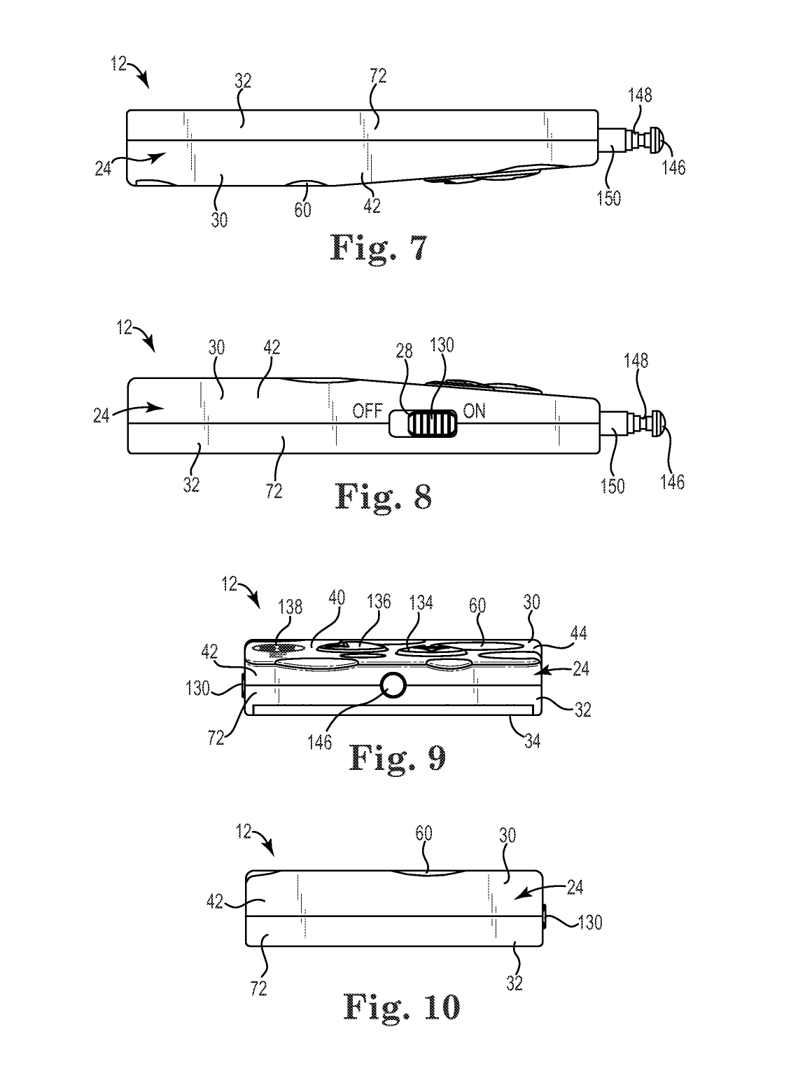

FIGS. 4-10 illustrate one example of transaction product 12. Referring to FIG. 6, for example, transaction product 12 includes at least one account activation area or account identifier 20, such as a bar code, magnetic strip, a smart chip or other electronic device, a radio frequency identification (RFID) device or other suitable identifier readily machine readable by a point-of-sale terminal or other account access station or kiosk. Account identifier 20 indicates an account or record to which transaction product 12 is linked. The account or record of the monetary or other balance on transaction product 12 optionally is maintained on a remote database accessible by corresponding point-of-sale terminals, other electronic or manual record-keeping system or, in the case of “smart” cards for example, on a chip or other electronic device(s) on transaction product 12 itself. Accordingly, by scanning account identifier 20, the account or record linked to transaction product 12 is identified and can subsequently be activated, have amounts debited therefrom, and/or have amounts added thereto.

In one embodiment, account identifier 20 includes a character string or code 22 (e.g., a number and/or letter string) configured to provide additional security to the user of transaction product 12 and/or configured to be read by a bearer of transaction product 12 to facilitate use of transaction product 12 for website or other purchases outside of brick-and-mortar type retail establishments. With the above in mind, account identifier 20 is one example of means for linking transaction product 12 with an account or record, and scanning of account identifier 20 is one example of means for activating or loading value on transaction product 12. Transaction product 12 is one example of means for supporting account identifier 20. Notably, although primarily described as including account identifier 20 on transaction product 12, in one embodiment, account identifier 20 optionally included on auxiliary vehicle 14 in addition or as an alternative to transaction product 12.

In one embodiment, transaction product 12 includes an enclosure or housing 24 substantially enclosing or at least supporting a transmitting electrical assembly 26, and one or more switches 28 providing means for user interaction with transmitting electrical assembly 26. In one embodiment, housing 24 includes a first housing member 30, a second housing member 32, and a third housing member 34. In one example, transmitting electrical assembly 26 is substantially entirely enclosed between at least first housing member 30 and second housing member 32.

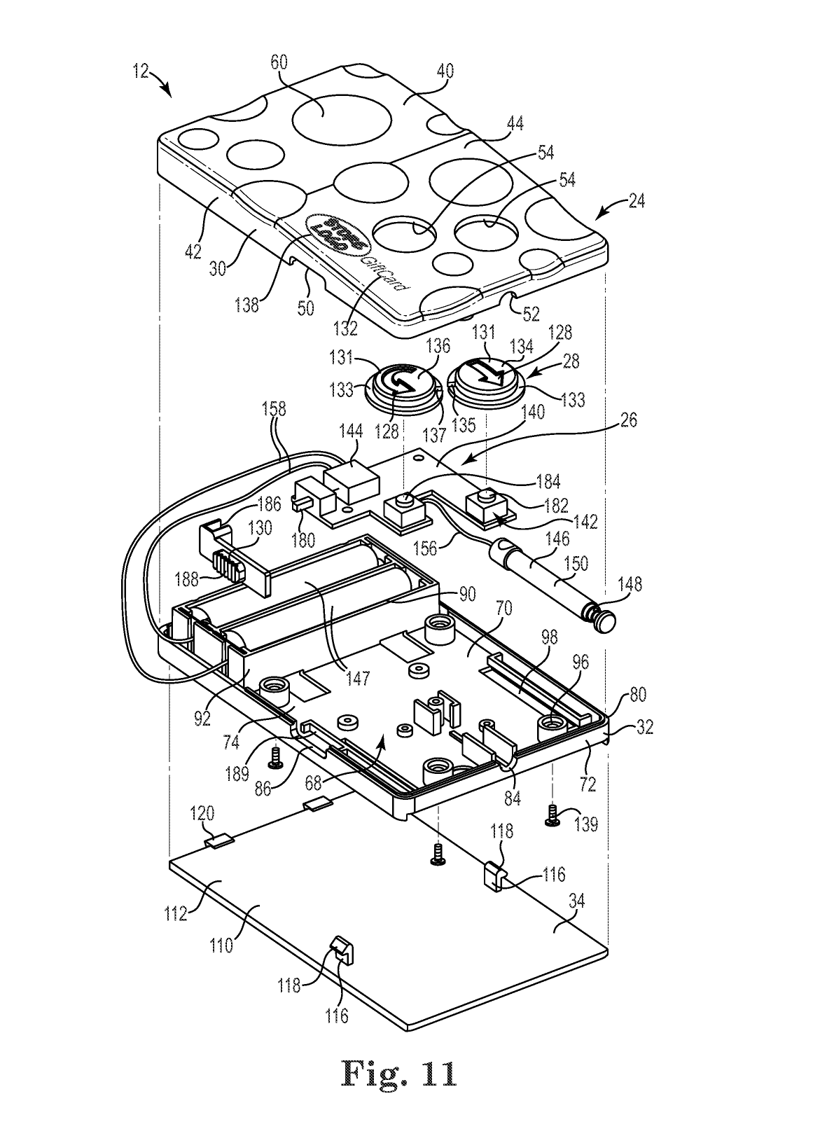

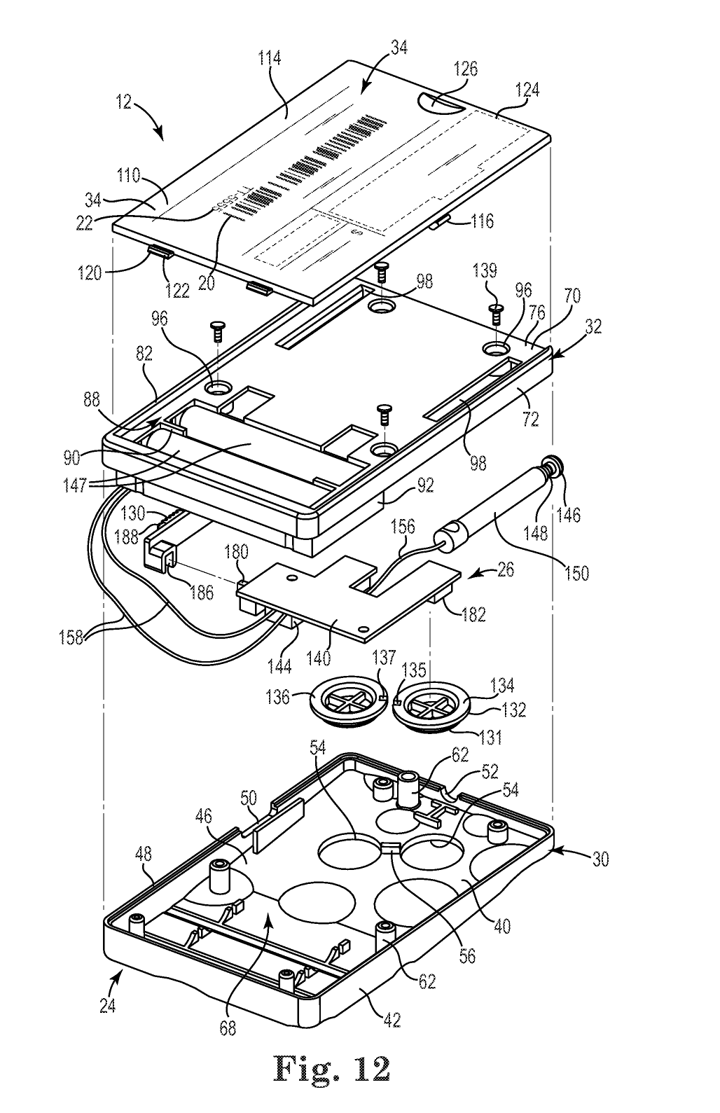

Referring to primarily to FIGS. 11 and 12, in one example, first housing member 30 includes a primary or support panel 40 and sidewall 42 extending around a substantial entirety of an outer perimeter of support panel 40. In one embodiment, support panel 40 is substantially rectangular and is sized similar to an identification card, a credit card, a debit card, or other wallet-sized card. In one example, support panel 40 is about 8.5 cm long and about 5.4 cm wide. In other embodiments, support panel 40 takes on any other suitable shape, such as a square, oval, circle, star, etc. Support panel 40 defines an outside surface 44 and an inside surface 46 opposite the outer surface 44.

Sidewall 42 extends from inside surface 46 about a substantial entirety of an outer perimeter of support panel 40 in a direction away from outside surface 44 to a free edge 48. In one example, sidewall 42 extends from inside surface 46 with a substantially perpendicular orientation relative to inside surface 46 or at least a substantial portion thereof. In one embodiment, free edge 48 is stepped or otherwise formed to increase the integrity of a connection between first housing member 30 and second housing member 32 as will be further described below.

In one embodiment, one or more cutouts are formed in sidewall 42 to accommodate the one or more switches 28, which extend through housing 24 to interface with both transmitting electrical assembly 26 and to selectively interface with a user of transaction product 12. For example, sidewall 42 defines a side switch cutout 50 extending from free edge 48 toward support panel 40. In one embodiment, sidewall 42 at least partially defines an antenna cutout 52, for instance, extending form free edge 48 toward support panel 40. Cutouts for the one or more switches 28 may additionally or alternatively be defined in other portions of housing 24. For example, one or more apertures 54 extend through support panel 40 and are each configured to allow one or more switch to extend from inside housing 24 to outside housing 24. In one embodiment, two apertures 54 are defined near one another with a registration protrusion 56 extending away from inside surface 46 between each of the two apertures 54.

First housing member 30, according to one embodiment, includes one or more protrusions or alignment mechanisms such as threaded cylinders 62 extending from inside surface 46 away from support panel 40, such as, for example, in a direction substantially perpendicular to support panel 40 and/or parallel to sidewall 42. First housing member 30 may include various other features as will be apparent to those of skill in the art. In one example, where transaction product 12 is designed to look like a wedge or slice of cheese, various indentations 60 are formed in outside surface 44 of support panel 40 to increase the visual correspondence with cheese, etc.

Second housing member 32 is formed in any suitable manner and, in one embodiment, is configured to fit with first housing member 30 to form a cavity 68 therebetween, for example, to hold transmitting electrical assembly 26. In one embodiment, second housing member 32 includes a primary or support panel 70 and sidewall 72 extending around a substantial entirety of an outer perimeter of the support panel 70. In one embodiment, support panel 70 is substantially rectangular and is sized similar to an identification card, a credit card, a debit card, or other wallet-sized chard. In one example, support panel 70 is about 8.5 cm long and about 5.4 cm wide. In other embodiments, support panel 70 takes on any other suitable shape, such as a square, oval, circle, star, etc. Support panel 70 defines an outside surface 74 and an inside surface 76 opposite the outer surface 74.

Sidewall 72 extends substantially perpendicular to support panel 70 about a substantial entirety of an outer perimeter of support panel 70. In one embodiment, sidewall 72 extends both above and below support panel 70 per the orientation of FIG. 11. As such, sidewall 72 defines an inner edge 80 facing toward first housing member 30 when housing 24 is assembled, and an outer edge 82 facing away from first housing member 30 when housing 24 is assembled. In one example, inner edge 80 is opposite and faces in an opposing direction than outer edge 82. In one embodiment, inner edge 80 is stepped or otherwise formed to increase the integrity of a connection between first housing member 30 and second housing member 32 interfacing with free edge 48 as will be further described below.

In one embodiment, one or more cutouts are formed in sidewall 72 to accommodate the one or more switches 28, which extend through housing 24 to interface with both transmitting electrical assembly 26 and to selectively interface with a user of transaction product 12. For example, sidewall 72 defines a side switch cutout 86 extending from inner edge 82 toward support panel 70. In one embodiment, sidewall 72 at least partially defines an antenna cutout 84, for instance, extending from inner edge 80 toward support panel 70. Cutouts for the one or more switches 28 may additionally or alternatively be defined in other portions of housing 24. In one embodiment, the extension of sidewall 72 below support panel 70 to outer edge 82 defines a recess 88 below support panel 70 and confined by sidewall 72. In one embodiment, sidewall 72 only extends below support panel 70 on three of four sides such that outer edge 82 is only formed along three of four sides of transaction product 12.

In the embodiment illustrated in FIGS. 11 and 12, second housing member 32 includes a battery chamber 90 surrounded by interior walls 92. Interior walls 92 extend beyond at least one side (e.g., a top or bottom side) of support panel 70. For example, interior walls 92 extend from inside surface 74 away from support panel 70 defining battery chamber 90 accessible from either top or bottom side of battery chamber 90 (i.e., either through outside surface 74 of support panel 70 or from an opposite side of battery chamber 90). Other placements of battery chamber 90 and/or interior walls 92 configured to accommodate size and component configurations of transaction product 12 are also contemplated and will be apparent to those of skill in the art upon reading the present application.

Second housing member 32, according to one embodiment, includes one or more recessed screw receptors 96 extending from outside surface 76 and through support panel 72 configured to receive screws 139 or other connecting devices to facilitate coupling of first housing member 30 and second housing member 32. Second housing member 32 may include various other features as will be apparent to those of skill in the art. In one embodiment, support panel 70 of second housing member 32 defines opposing linear slots 98. As illustrated, opposing linear slots 98 are each positioned near opposing parallel lengths of sidewall 72. In one example, each opposing linear slot 98 extends entirely through support panel 70 from and between inside surface 74 and outside surface 76.

In one embodiment, third housing member 34 includes a primary panel 110, which is substantially planar and defines an inside surface 112 and an outside surface 114 opposite inside surface 112. In one example, primary panel 110 is substantially rectangular and sized and shaped to fit within recess 88 of second housing member 32. In one embodiment, account identifier 20 is statically secured to (e.g., printed or otherwise substantially immovably secured to) outside surface 114 while in other embodiments, account identifier 20 is statically secured to another suitable portion of housing 24.

In one example, third housing member 34 includes two opposing protruding members 116 near opposing parallel lengths of third housing member 34. Each protruding member extends from inside surface 112 away from outside surface 114. In one example, each protruding member 116 includes a hooked end 118 extending from a primary shaft of protruding member 116 opposite inside surface 112 and defining at least a portion extending substantially parallel to inside surface 112. In one embodiment, a distance between protruding members 116 is similar or substantially identical to the distance between opposing linear slots 98.

In one example, third housing member 34 includes end tabs 120 extending from a first linear end of third housing member 34 and a finger tab 126 formed by outside surface 114 near an opposite second linear end of third housing member 34. In one example, each end tab 120 has a slightly enlarged free end 122 configured to interact with second housing member 32 as will be further described below. In one embodiment, outside surface 114 of third housing member 34 includes redemption indicia 124. Redemption indicia 124 indicate that transaction product 12 is redeemable for the purchase of goods and/or services and that, upon use, a value of the purchased goods and/or services will be deducted from the account or record linked to transaction product 12. In one embodiment, redemption indicia 124 include phrases such as “<NAME OF STORE> GiftCard” and “This GiftCard is redeemable for merchandise or services at any of our stores or at our website,” and/or provides help or phone line information in the case of a lost, stolen, or damaged transaction product, etc.

As illustrated in FIGS. 4-12, housing 24 is configured to be assembled to substantially enclose transmitting electrical assembly 26. In particular, according to one embodiment, first housing member 30 is a cover of housing 24, and second housing member 32 and third housing member 34 collectively form a base of housing 24. In one example, first housing member 30 and second housing member 32 are coupled to one another in a manner mating free edge 48 of first housing member 30 and inner edge 80 of second housing member 32 to one another. Free edge 48 and inner edge 80 are, in one example, glued, ultrasonically welded, and/or otherwise secured to one another. In one embodiment, screws 139 or other connection devices are inserted through recessed screw receptors 96 of second housing member 32 and into threaded cylinders 62 of first housing member 30 to additionally or alternatively secured first housing member 30 to second housing member 32.

In one example, the one or more switches 28, which each interface with transmitting electrical assembly 26 as will be further described below, are inserted into position relative to housing 24 before first housing member 30 and second housing member 32 are assembled to one another. For instance, in one embodiment, the one or more switches 28 includes an on/off switch 130, a directional button 134, and a turn button 136, although inclusion of other switches will be apparent to those of skill in the art upon reading this application. In one example, on/off switch 130 is sized and shaped to fit at least partially within an opening in housing 24 collectively defined by switch cutout 50 of first housing member 30 and switch cutout 86 of second housing member 32. In one embodiment, on/off switch 130 is a push button or slide switch, in which instance, the opening in housing 24 collectively defined by switch cutout 50 and switch cutout 86 is sized to allow on/off switch 130 to linearly slide therein. In one example, housing 24 includes indicia 132 configured to inform a user regarding use of on/off switch 130, for instance, by stating which of two positions for on/off switch 130 is “on” and which is “off.”

In one example, directional button 134 and turn button 136 are considered vehicle control switches and maybe one of a plurality of control switches and/or replaced with other control switches to control movement of auxiliary vehicle 14 as will be apparent to those of skill in the art upon reading the present application. In one embodiment, each of directional button 134 and turn button 136 is sized and shaped to be positioned within a different one of switch apertures 54 in a manner that, in one example, extends to and/or slightly protrudes beyond outside surface 44 of first housing member 30. More specifically, each of directional button 134 and turn button 136 includes a protruding portion 131, which extends through the respective switch aperture 54, and a rim 133 extending around and radially outwardly from an outside perimeter of protruding portion 131 to hold each respective button 134 or 136 within housing 24.

In one embodiment, each rim 133 defines a registration cutout or registration slot 135 or 137 sized and shaped to receive registration protrusion 56 of first housing member 30 to facilitate proper positioning of switches 134 and 136 relative to first housing member 30. In one example, each protruding portion 131 includes instructional indicia 128 (see, e.g., FIG. 11) for use of directional button 134 and turn button 136 and interaction between registration slots 135 and 137 and registration protrusion 56 assists in ensuring instructional indicia 128 are properly orientated relative to first housing member 30 and transmitting electrical assembly 26. For example, as indicated in FIGS. 4, 5, and 11, directional button 134 controls the forward or backward motorized direction in which auxiliary vehicle 14 moves while turn button 136 controls right or left turning of auxiliary vehicle.

Housing 24 is formed of any suitable substrate or combination of substrates. In one example, housing 24 is formed from a somewhat rigid yet flexible material in a substantially planar form. More specifically, in one embodiment, housing 24 is formed of plastic (e.g. polycarbonate, polystyrene, polyvinyl chloride (PVC), acrylonitrile butadiene styrene (ABS), polyethylene terephthalate (PET), teslin, polyactide (PLA) or acrylic), a composite, or other suitable material. In one embodiment, each of first housing member 30, second housing member 32, and third housing member 34 and/or any of the one or more switches 28 are each formed as single pieces of injection molded plastic. Housing 24 can be formed in any other suitable planar or non-planar configuration as will be apparent to those of skill in the art upon reading this application.

In one embodiment, housing 24, for example, outside surface 44 of first housing member 30, includes brand indicia 138. In one example, brand indicia 132 include one or more of a logo, text, trademark, etc. that associate transaction product 12 with at least one of a product, a brand, a store, department, etc. Upon reading this application, one having ordinary skill in the art will recognize that various components of housing 24 may be included on different portions thereof than as specifically described in this application. For example, while primarily described above as being defined solely by first housing member 30, switch apertures 54 may be wholly or partially formed by another one of second housing member 32 and third housing member 34.

In one embodiment, third housing member 34 is coupled with second housing member in a slidable manner directly over outside surface 76 of support panel 70 such that third housing member 34 is a door. For example, each one of opposing protruding members 116 is positioned to extend through a different one of opposing linear slots 98 formed through support panel 70 of second housing member. Each protruding member 116 is sized and shaped such that hooked end 118 interacts with inside surface 74 of support panel 70 to hold third housing member 34 to second housing member 34 while allowing linear sliding along the length of the respective opposing linear slot 98. As such, the interaction of protruding members 116 with linear slots 98 allows third housing member 34 to linearly slide relative to second housing member 36 to selectively at least partially expose and cover outside surface 76 and battery chamber 90 of second housing member 32. In one example, interaction of protruding members 116 and linear slots 98 substantially permanently couples second housing member 32 and third housing member 34 to one another while still allowing the slidable interaction described above.

Third housing member 34, according to one embodiment, includes locking tabs 120 on an edge of third housing member 34, for example, an edge of third housing member 34 perpendicular to the edges protruding members 116 are positioned near. Each locking tab 120 extends away from a remainder of third housing member 34 and, in one embodiment, includes a slightly enlarged free end 122 configured to interact with corresponding slots or holes (not shown) formed by second housing member 32 to selectively hold third housing member 34 in place relative to second housing member 32 as will be further described below. In one example, third housing member 34 includes a finger tab 126 positioned near an edge opposite locking tabs 120 to facilitate a user's interaction with third housing member 34 to slide or otherwise manipulate third housing member to move it relative to second housing member 32, for example, between an open and closed position relative to battery chamber 90, as desired. Although primarily disclosed herein as being two separately formed pieces, in one embodiment, second housing member 32 and third housing member 34 are alternatively formed as a single piece and, therefore, are statically maintained relative to one another.

In one example, third housing member 34 or any other suitable portion of housing 24 includes redemption indicia, generally indicated by a dashed box 124 in FIGS. 6 and 12, indicating that transaction product 12 is redeemable for the purchase of goods and/or services and that upon use, a value of the purchased goods and/or services will be deducted from the financial account or record linked to transaction product 12. In one embodiment, redemption indicia 124 include phrases such as “<NAME OF STORE> GiftCard” and “This GiftCard is redeemable for merchandise or services at any of our stores or at our website,” and/or provides help or phone line information in case of a lost, stolen, or damaged transaction product, etc.

In one embodiment, various other indicia are alternatively or additionally included on housing 24 as will be apparent to those of skill in the art upon reading the present application. For example, housing indicia 132 includes instructional indicia, decorative indicia, and/or promotional indicia. In one embodiment, housing 24 includes brand indicia 138, which identify a store, brand, department, etc. and/or services associated with transaction product 12.

Referring primarily to FIGS. 11 and 12, in one embodiment, transmitting electrical assembly 26 is configured to receive instructions from a user, to use the instructions to generate corresponding radio frequency or similar communication means, and to output the radio frequency, etc. to auxiliary vehicle 14. Transmitting electrical assembly 26 is formed in any suitable embodiment to so function. In one example, transmitting electrical assembly 26 includes printed circuit board (PCB) 140, electrical switches 142, control circuit 144, a communication transmitter or antenna 146, and/or one or more battery or other power source 147. In one example, PCB 140 supports a significant portion of transmitting electrical assembly 26 and provides for electrical communication contacts and links between components of transmitting electrical assembly 26.

In one embodiment, transmitting electrical assembly 26 includes various electrical switches 142 for interfacing with physical buttons or switches 28 and for effectuating particular radio frequency output via antenna 146, for powering transmitting electrical assembly 26 from power source 147 and/or for other effectuating a desired electrical response from transmitting electrical assembly 26. Electrical switches 142 include any one or more of a pressure sensitive switch, a slidable switch, or any other suitable switch as will be apparent to those of skill in the art upon reading this application. In one example, electrical switches 142 include one or more of on/off switch 180, directional switch 182, turn switch 184, and/or any other suitable switch.

On/off switch 180 interfaces with a remainder of transmitting electrical assembly 26 to cause power to be drawn from power source 147 (i.e., turn transmitting electrical assembly 26 on) or to cease power from being drawing from power source 147 (i.e., turn transmitting electrical assembly 26 off). As illustrated, on/off switch 180 includes a slidable arm extending outwardly from the remainder of transmitting electrical assembly 26. Directional switch 182 is a pressure sensitive switch in the illustrated embodiments, that when pressed or pushed by a user causes transmitting electrical assembly 26 to transmit a radio or other suitable signal to the remote auxiliary vehicle 14 instructing auxiliary vehicle 14 to move forward or in another indicated direction. Turn switch 184 is a pressure sensitive switch in the illustrated embodiments, that when pressed or pushed by a user causes transmitting electrical assembly 26 to transmit a radio or other suitable signal to the remote auxiliary vehicle 14 instructing auxiliary vehicle 14 to turn to the right or left. Additional switches 142 may be added or substituted as will be apparent to those of skill in the art upon reading this application.

In one embodiment, control circuit 144 is positioned on or otherwise in communication with PCB 140 and generally controls the receipt of electrical signals and generation of radio or other signals for transmission. In one example, power source 147 is connected to a remainder of transmitting electrical assembly 26 via power cords 158. Antenna 146 is coupled with a remainder of transmitting electrical assembly 26 via antenna connector 156 such as a wire, cord, etc. and is configured to transmit radio or other suitable signals to auxiliary vehicle 14 in, for example, a wireless manner. In one embodiment, antenna 146 includes an arrangement of telescoping members 148 selectively positioned within and configured to selectively extend substantially out of a primary shaft 150 of antenna 146 to increase the range at which the radio or other signals can be transmitted to auxiliary member 14. In view of the above, transmitting electrical assembly 26, and therefore, transaction product 12 as a whole, functions as a transmitter configured to wirelessly and remotely control auxiliary vehicle 14 via radio or other suitable signals output thereto based on user interaction with electrical switches 142.

In one embodiment, transaction product 12 is assembled by first positioning transmitting electrical assembly 26 within housing 12 or at least securing transmitting electrical assembly 26 to a portion thereof, such as second housing member 32. For example, batteries or power source 147 is positioned within battery chamber 90. A portion of transmitting electrical assembly 26 for interfacing with power source 147 is also placed within or adjacent battery chamber 90 to extract power from power source 147.

In one example, PCB 140 and all components thereon are mounted to a portion of inside surface 74 of support panel 70. More specifically, PCB 140 is mounted to inside surface 74 of support panel 70 such that on/of switch 180 extends out of switch cutout 86 in sidewall 72 of second housing member 32 and antenna 146 is positioned to at least partially extend through antenna cutout 84 in sidewall 72 of second housing member 32. PCB 140 and any other portions of transmitting electrical assembly 26 are mountable to support panel 70 in any suitable manner such as via adhesive, ultrasonic welding, etc.

Button or switch 130 is positioned to receive the extending portion of on/off switch 180. For example, switch 130 is molded of a single piece of material and includes a receptor portion 186 for receiving and/or being coupled with on/off switch 180. Switch 130 is positioned just inside sidewall 72 adjacent cutout 86 such that an interface portion 188 thereof with, for example, a grooved gripping surface extends through cutout 86. In one embodiment, switch 130 is configured to slide relative to transmitting electrical assembly 26 and second housing member 32 to move on/off switch 180 to turn power flow from power source 147 on and off relative to a remainder of transmitting electrical assembly 26. In one embodiment, second housing member 32 includes a protruding track 189 extending from support panel 70 to facilitate positioning and slidable, linear movement of switch 130 relative to housing 24.

In one example, buttons 134 and 136 are placed to extend through the corresponding button apertures 54 defined by first housing member 30, for instance such that respective rims 133 remain adjacent inside surface 46 of support panel 40 and protruding portion 131 extends through the respective one of button apertures 54. In one embodiment, each registration slot 135 is positioned to receive a corresponding end of registration protrusion 56 as will be apparent upon viewing FIG. 12. After buttons 134 and 136 are positioned, then, in one embodiment, first housing member 30 and second housing member 32 are assembled with on another. More specifically, free edge 48 of first housing member 30 is positioned to abut inner edge 80 of second housing member 32 such that switch cutouts 50 and 86 align and antenna cutouts 52 and 84 align with one another. As such, first switch 130 extends out of housing 24 via an aperture collectively defined by switch cutouts 50 and 86, and antenna 146 extends out of the housing via the aperture collectively defined by antenna cutouts 52 and 84. Upon assembly of first housing member 30 and second housing member 32, transmitting electrical assembly 26 is substantially entirely enclosed therebetween, and, in one embodiment, buttons 134 an 136 are each positioned to respectively interface with directional switch 182 and turn switch 184 of transmitting electrical assembly 26 such that depression of one of buttons 134 and 136 causes depression and activation of one of directional switch 182 and turn switch 184.

In one example, coupling first housing member 30 with second housing member 32 includes aligning threaded cylinders 62 of first housing member 30 with recessed receptors 96 of second housing member 32 and inserting screws 139 or other suitable connecting members through recessed receptors 96 and into threaded cylinders 62 to more securely couple first housing member 30 and second housing member 32. In one example, adhesive or ultrasonic welding is alternatively or additionally used to secure free edge 48 to inner edge 80.

In one embodiment, third housing member 34 is slidably coupled with second housing member 32. Referring primarily to FIG. 12, in one example, third housing member 34 is sized and shaped to fit and is positioned within recess 88, where recess 88 is defined externally to outside surface 76 of support panel 70 and between portions of sidewall 72 extending on an external side of outside surface 76. Since sidewall 72 only extends beyond outside surface 76 on three sides thereof, third housing member 34 is slid into position through the open side and in between the surrounded three sides. In one example, protruding members 116 are positioned to each extend through a different one of opposing linear slots 98 such that the hooked end 118 of each protruding member grasps inside surface 74 of support panel 70 to hold second housing member 32 and third housing member 34 together while still allowing third housing member 34 to linearly slide relative to second housing member 32. In one embodiment, a length of linear slots 98 limits slidable movement of third housing member 34 relative to second housing member 32.

When third housing member 34 is in a closed position such that no portion thereof extends beyond sidewall 72 of second housing member 32 as illustrated, for example, in FIGS. 4-10, locking tabs 120 interface with second housing member 32 to selectively hold or lock third housing member 34 in the closed position until a suitable force is applied to third housing member 34 to dislodge locking tabs 120 and slide third housing member 34 into an open position exposing battery chambers 90 to facilitate replacement of power source 147 when necessary. As a result, transaction product 12 is formed and fully functioning.

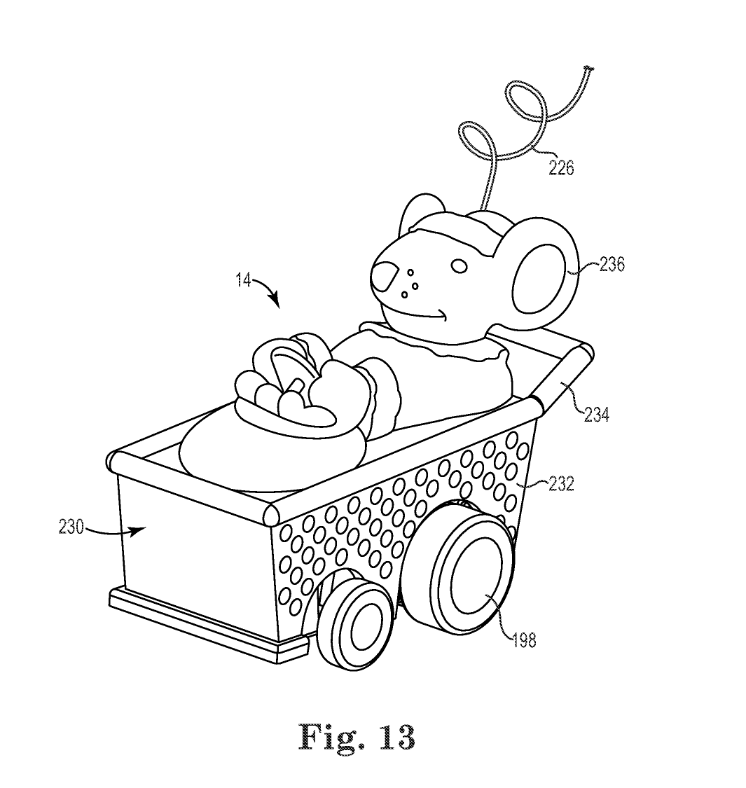

One example of auxiliary vehicle 14 is illustrated with reference to FIGS. 13-15. As illustrated, auxiliary vehicle 14 is a shopping cart carrying a mouse; however, one of skill in the art will realize upon reading this application that auxiliary vehicle 14 can take on any number of forms capable of having movement or functionality controlled by the transmissions received from transaction product 12. In one embodiment, auxiliary vehicle 14 depicts a car, truck, tractor, animal, person, character, or any other suitable object.

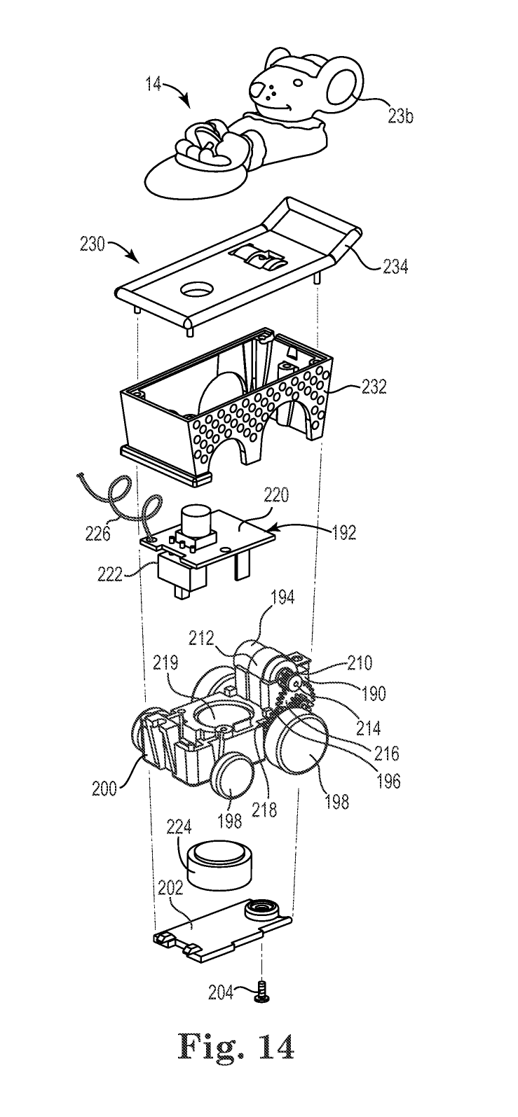

In one embodiment, auxiliary vehicle 14 includes a chassis 190, a receiving electrical assembly 192, a motor 194, a gear assembly 196, and wheels 198. Chassis 190 forms the supporting frame and structure of auxiliary vehicle 14 and is configured to receive and support each of receiving electrical assembly 192, motor 194, gear assembly 196, and wheels 198. In one example, chassis 190 includes a primary chassis structure 200 and a bottom chassis panel 202. Primary chassis structure 200 forms the majority of chassis 190 and includes a motor cavity 210 a battery reception cavity 219 (FIG. 14) and axle reception cavities (not shown).

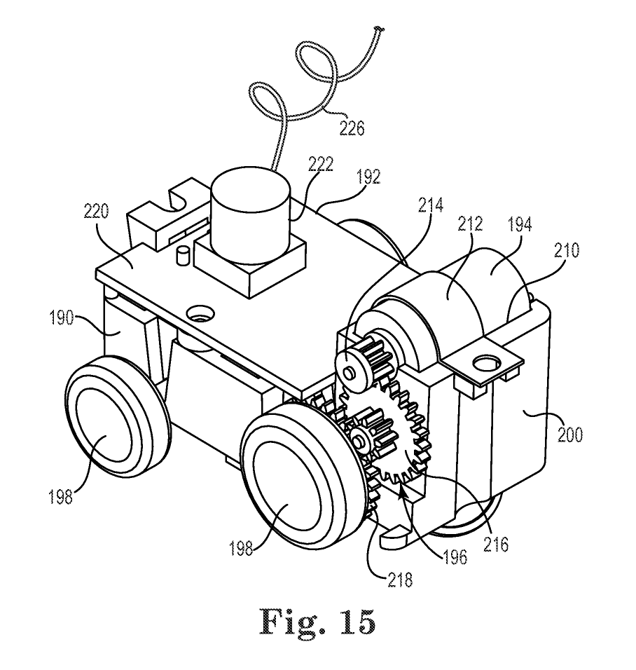

Upon assembly of auxiliary vehicle 14, a suitable mechanical motor 194 is positioned within motor cavity 210 and, in one example, is secured within motor cavity 210 via a motor bracket 212 extending across motor 194 as illustrated in FIGS. 14 and 15. Gear assembly 196 is coupled with motor 194 and primary chassis structure 200. In one embodiment, gear assembly 196 includes a motor gear 214, one or more transfer gears 216, and wheel gear 218. Motor gear 214 is received on an axle (not shown) extending out of and configured to be rotatably driven by motor 194. Wheel gear 218 is positioned on an axle (not shown) extending through primary chassis structure 200 and supporting at least one of wheels 198. Transfer gears 216 are positioned to interface with motor gear 214 and wheel gear 218 to transfer rotational force from motor gear 214 to wheel gear 218 and its axle resulting in rotation of wheels 198 as will be apparent to those of skill in the art upon reading this application.

Receiving electrical assembly 192 is also mounted on primary chassis structure 200. In one embodiment, receiving electrical assembly 192 includes printed circuit board (PCB) 220, a control circuit 222, a battery 224, a radio or other frequency receiver such as an antenna 226. PCB 220 is mounted to primary chassis structure 200 in any suitable manner and is placed in electrical communication with motor 194 such that motor 194 is controlled via the electrical signals received from control circuit 222. Battery 224 or other suitable power source is placed in battery cavity 219 and in electrical communication with control circuit 222 to power functionality thereof. In one embodiment, battery 224 is placed within battery cavity 219 from a lower opening (not shown) thereto and bottom chassis panel 202 is selectively coupled with primary chassis structure 200 to hold battery 224 in place. In one example, a screw or other connection device 204 extends through a hole (not shown) in bottom chassis panel 202 and into primary chassis structure 200. Bottom chassis panel 202 can be moved or removed to allow user access to battery 224 for replacement, etc. In one embodiment, auxiliary vehicle 14 includes its own on/off switch (not shown) to power on and off receiving electrical assembly 192.

Antenna 226 is coupled with control circuit 222, for example, via the connections in PCB 220 and is configured to receive the radio or other suitable frequency signals from transaction product 12. Control circuit 222 is configured to receive the frequency signals and convert them to electrical signals sent to motor 194 and other suitable portions of auxiliary vehicle 14 to remotely control its movements, for example, to control straight line and turning movements of auxiliary vehicle 14.

In one embodiment, auxiliary vehicle 14 additionally includes a body 230 configured to cover a large or substantial portion of chassis 190, receiving electrical assembly 192, motor 194, and gear assembly 196 to increase the aesthetic appeal of auxiliary vehicle 14. In one example, body 230 fits over the top of primary chassis structure 200 leaving substantially only wheels 198 and bottom chassis panel 202 exposed. In one embodiment, such as that illustrated in FIGS. 13-15, body 230 includes first body member 232, second body member 234, and third body member 236 assembled to one another. First body member 232 includes sides of auxiliary vehicle 14 such as the sides of a shopping cart in the illustrated depiction. Second body member 234 includes a top of body 230 extending over an open top (not shown) of first body member 232. In the embodiment illustrated, second body member 234 is configured to depict shopping cart handles and a top rim thereof. In one example, each of first body member 232 and second body member 234 are each separately formed of injection molded plastic. Third body member 236 is added primarily for aesthetic reasons, and in one embodiment, depicts a driver of auxiliary vehicle 14 such as a mouse with steering wheel or other suitable depiction and is coupled to second body member 234. Although described as being formed of multiple body members, one of skill in the art will recognize upon reading this application that in one embodiment, body 230 can be formed as a single piece of material.

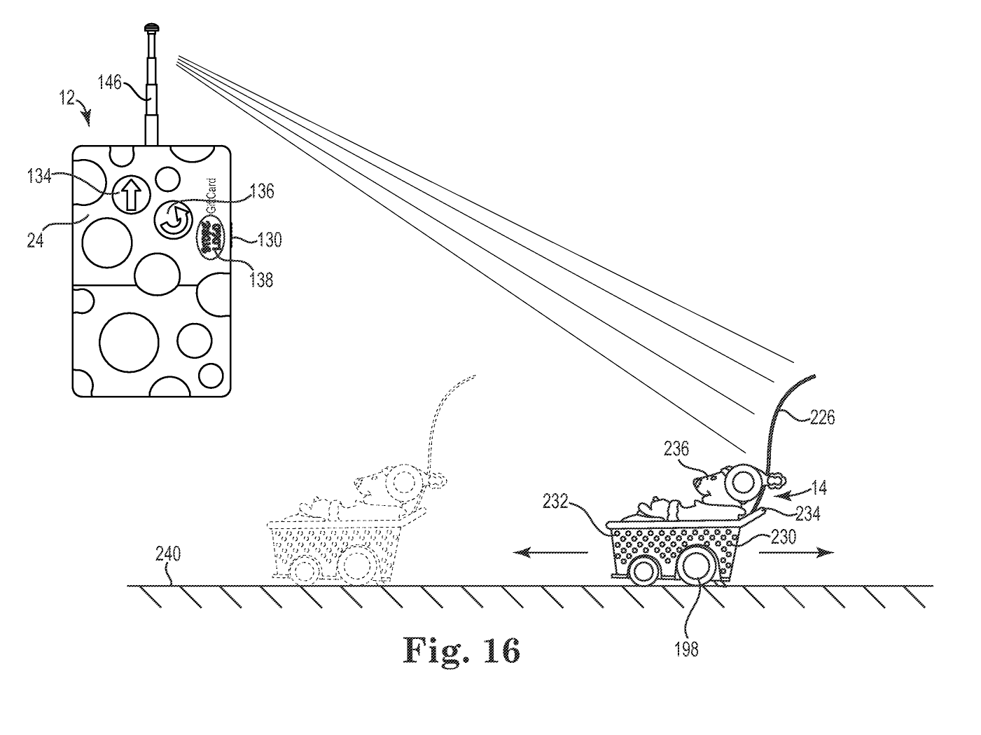

Referring to FIG. 16, during use, auxiliary vehicle 14, more specifically, wheels 198 are placed on a support surface 240. A user holding transaction product 12 interacts with switches 130, 132, and 134 causing transmitting electrical assembly 26 to generate or initiate radio or other suitable frequency signals existing and/or having instructional content based on the user interaction with one or more of switches 130, 132, and 134. The signals are output via antenna 146. When auxiliary vehicle 14 is in suitable range to transaction product 12, antenna 226 of auxiliary vehicle 14 receives the signals transmitted from antenna 146. Auxiliary vehicle 14 converts the signals into the corresponding mechanical motion based on the specific instructional content for movement received from transaction product 12 to move forward, backward, turn right, turn left, etc. in a manner providing amusement to the user of transaction product 12 and all in observance of auxiliary vehicle 14. Notably, while the controller or transmitter for transaction product assembly 10 is primarily referred to as transaction product 12, it should be understood that in one embodiment, account identifier 20 may alternatively be included on auxiliary vehicle 14 such that auxiliary vehicle 14 acts as the financial product and item 12 is merely a controller or transmitter without financial functionality. In one embodiment, both transaction product 12 and auxiliary vehicle 14 include account identifier 20 and have individual financial functionality.

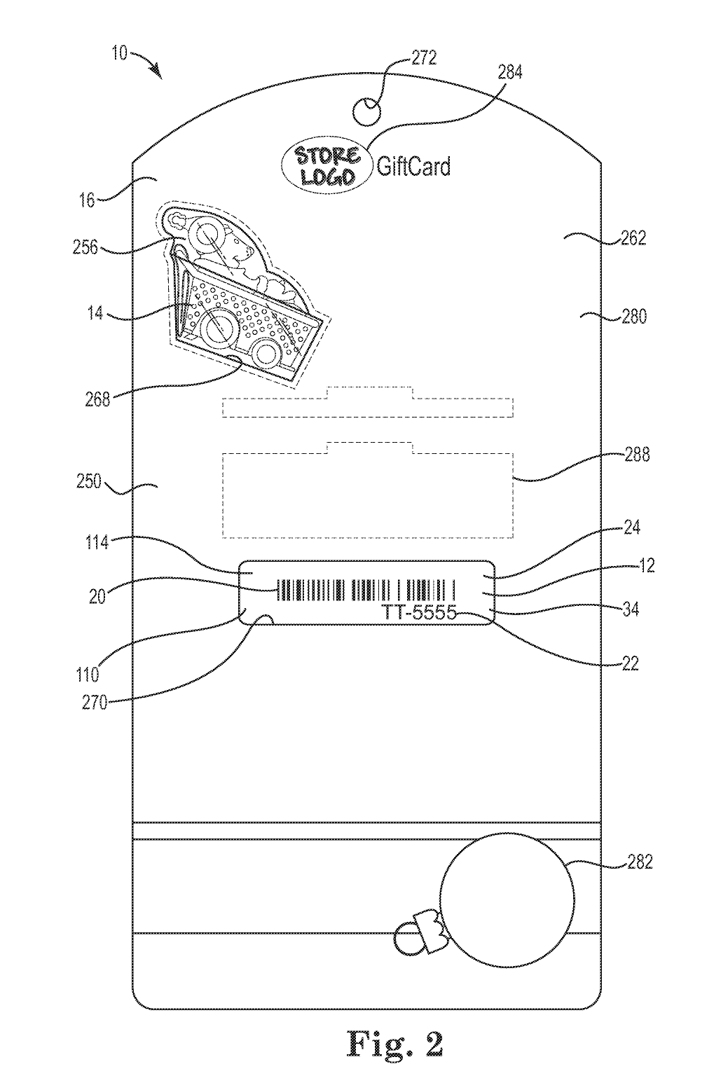

Transaction product 12 and auxiliary vehicle 14 are packaged with one another for retail display in any suitable manner. One example of package 16 is illustrated in FIGS. 1-3. As illustrated, in one embodiment, package 16 includes a support card 250 or backer, a first clamshell 252, a second clamshell 254, and a third clamshell 256. First clamshell 252 is configured to receive transaction product 12, second clamshell 254 is configured to receive a first side of auxiliary vehicle 14 and third clamshell 256 is configured to receive a second, opposite side of auxiliary vehicle 14. Each of first clamshell 252, second clamshell 254, and third clamshell 256 is one of transparent and translucent and defines a cavity 276 for receiving the respective portion of transaction product 12 or auxiliary vehicle 14 surrounded by a perimeter flange or frame 278 (shown in dashed, hidden lines in FIGS. 1 and 2) extending around cavity 276 in a substantially planar manner.

In one example, support card 250 includes a front panel 260 and a rear panel 262. Front panel 260 and rear panel 262 are both substantially planar and may be formed as separate pieces or as a single piece folded at or near an intersection between front panel 260 and rear panel 262. Front panel 260 and rear panel 262 are formed of any suitable supporting material such as paperboard, chipboard, cardboard, plastic sheeting, etc. In one example, front panel 260 defines a front of package 16 as viewed during retail display and rear panel 262 defines the rear of package 16. In one embodiment, first panel 260 defines a controller aperture 264 and a first vehicle aperture 266. Controller aperture 264 is configured to receive first clamshell 252 such that cavity 276 of first clamshell 252 substantially extends in front of front panel 260 while frame 278 of first clamshell 252 remains substantially entirely behind front panel 260. First vehicle aperture 264 is configured to receive second clamshell 254 such that cavity 276 of second clamshell 254 substantially extends in front of front panel 260 while frame 278 of second clamshell 254 remains substantially entirely behind front panel 260.

In one embodiment, rear panel 262 includes a second vehicle aperture 268 and an activation aperture 270. Second vehicle aperture 268 is configured to receive third clamshell 256 such that cavity 276 of third clamshell 256 substantially extends in back of rear panel 262 while frame 278 of second clamshell 254 remains substantially entirely in front of rear panel 260. Activation aperture 270 is any suitable size to provide access to account identifier 20 of transaction product 12 upon final assembly of package 16. In one embodiment, one or both of front panel 260 and rear panel 262 defines a hanging aperture 272 to facilitate hanging of transaction product assembly 10 for retail display.

Upon assembly, first clamshell 254 is placed in controller aperture 264 and transaction product 12 is placed in cavity 276 of first clamshell 254 such that outside surface 44 of first housing member 30 faces forwardly. In one embodiment, transaction product 12 fits entirely within cavity 276 of first clamshell 254. Second clamshell 256 is placed in first vehicle aperture 266 and auxiliary vehicle 14 is placed partially within cavity 276 of second clamshell 256. In one embodiment, auxiliary vehicle 14 does not fit entirely within cavity 276 of second clamshell 254 and, instead, extends beyond frame 278 of second clamshell 254. Third clamshell 258 is placed in second vehicle aperture 268. In one embodiment, transaction product assembly 10 includes an instructional paper or booklet (not shown), which may also be placed at least partially within first clamshell 254 or otherwise secured between front panel 260 and rear panel 262.

A front surface (not shown) of rear panel 262 is aligned with and coupled to, e.g., adhered to, a rear surface (not shown) of front panel 260. When front panel 260 and rear panel 262 are aligned, activation aperture 270 aligns with transaction product 12 such that account identifier 20 on transaction product 12 is visible through activation aperture 270 as illustrated in FIG. 2. Also, when front panel 260 and rear panel 262 are aligned and coupled together, second clamshell 254 and third clamshell 256 align with one another such that their cavities 276 are in direct communication with one another. In one example, in the resultant transaction product assembly 10, auxiliary vehicle 14 is partially maintained in cavities 276 of second clamshell 254 and third clamshell 256.

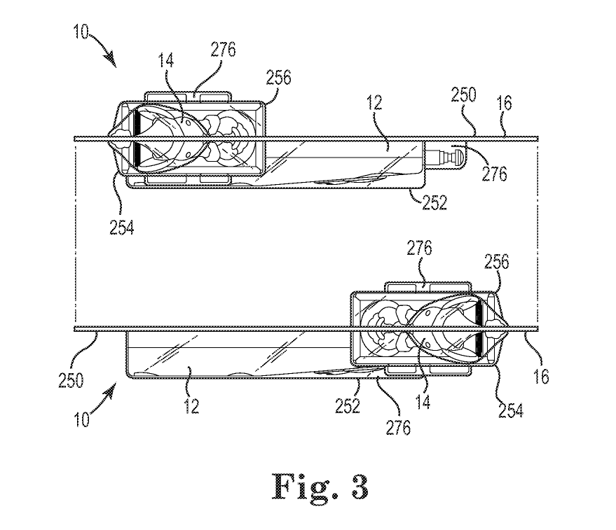

In one embodiment, auxiliary vehicle 14 is substantially thicker than transaction product 12, for example, about twice as thick. To allow for multiple transaction product assemblies 10 to be stacked during transport and display in a manner taking as little space as possible, the side of package 16 that includes vehicle apertures 266 and 268, second and third clamshells 254 and 256, and auxiliary vehicle 14 alternates between adjacent transaction product assemblies 10 as illustrated in FIG. 3. Other suitable packages 16 or alterations thereof will be apparent to those of skill in the art upon reading this application.

In one embodiment, package 16 includes displays, indicia, graphics or text information including store logo(s), store name(s), slogans, advertising, instructions, directions, brand indicia, promotional information, holiday indicia, seasonal indicia, media format identifiers, characters and/or other information on external surfaces 280 of front panel 260 and rear panel 262 (i.e., front surface of front panel 260 and rear surface of rear panel 262).

For example, in one embodiment, support card 250 includes decorative indicia 282, which makes package 16 more aesthetically pleasing to potential consumers, and also, in one example, ties package 16 to the overall appearance of transaction product 12 and auxiliary vehicle 14. For instance, decorative indicia 282 provide background scenery or other related graphics to a common theme of auxiliary vehicle 14 and transaction product 12.

In one embodiment, support card 250 includes brand indicia 284, which identify a store, brand, department, etc. and/or services associated with transaction product 12. In one example, support card 250 includes indicia 286 including to, from, and amount fields. The fields of indicia 286 provide areas of support card 250 configured to be written upon by a consumer to personalize support card 250 for presentation as a gift to a particular recipient, for a particular purpose, and/or to indicate a value of transaction product 12.

In one embodiment, support card 250 includes redemption indicia 288, generally indicated by a dashed box in FIG. 2, indicating that transaction product 12 is redeemable for the purchase of goods and/or services and that upon use, a value of the purchased goods and/or services will be deducted from the financial account or record linked to transaction product 12. In one embodiment, redemption indicia 288 include phrases such as “<NAME OF STORE> GiftCard” and “This GiftCard is redeemable for merchandise or services at any of our stores or at our website,” and/or provides help or phone line information in case of a lost, stolen, or damaged transaction product, etc.

As illustrated in FIGS. 1 and 2, in one example, support card 250 includes promotional indicia 290 advertising the non-transactional or amusing functionality of transaction product 12. In one embodiment, promotional indicia 290 generally indicate to a bearer of transaction product assembly 10 that upon interaction with transaction product 12, for example, corresponding movement of auxiliary vehicle 14 will be induced. As such, promotional indicia 290 further promotes the sale of transaction product assembly 10 by drawing the attention of a potential consumer to the non-transactional and amusing feature(s) of transaction product assembly 10.

Any of indicia 124, 282, 284, 286, 288, and 290, account identifier 20, and/or other indicia optionally may appear anywhere on support card 250 or transaction product 12. Additional information besides that specifically described and illustrated herein may also be included and/or one or more of indicia 124, 282, 284, 286, 288, and 290 may be eliminated.

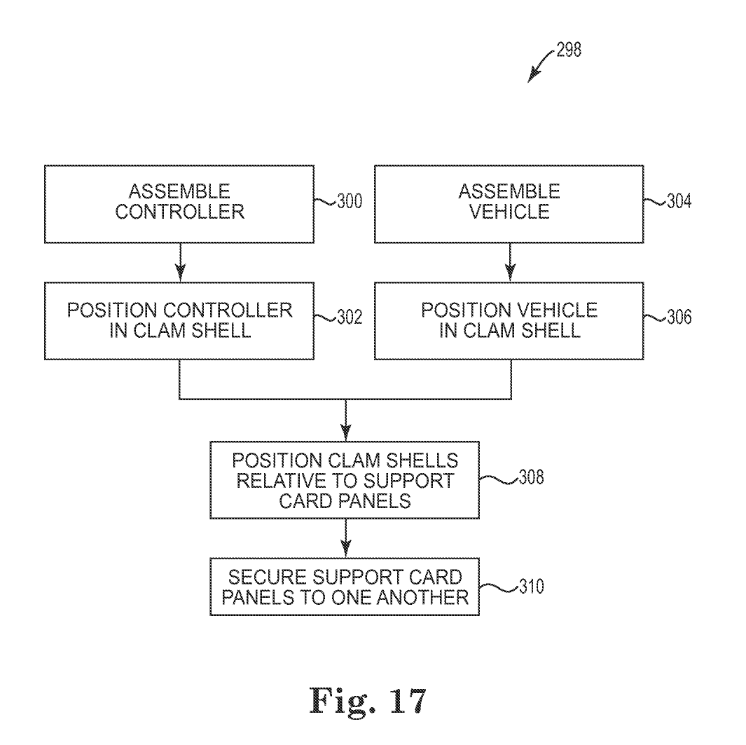

FIG. 17 is a flow chart illustrating a method of assembling transaction product assembly 10 as generally indicated at 298 described with additional reference to at least FIGS. 1-3, 11, and 12. At 300, transaction product 12 (i.e., the controller or transmitter) is assembled in any suitable manner such as by manufacturing transaction product 12 as described above and/or receiving transaction product 12 from another party. Following assembly of transaction product 12, then at 302, transaction product 12 is placed in cavity 276 of first clamshell 252. At 304, auxiliary vehicle 14 is assembled in any suitable manner, for example, as described in detail above. At 306, assembled auxiliary vehicle 14 is placed in one of second clamshell 254 or third clamshell 256. In one embodiment, operations 300 and 302 are completed one of before, substantially simultaneous with, and after operations 304 and 306.

At 308, first clamshell 252, second clamshell 254, and third clamshell 256 are each positioned within their respective apertures of support card 250, for example, within controller aperture 264, first vehicle aperture 266, and second vehicle aperture 268, respectively. In one example, instructions are also placed in one of first clamshell 252, second clamshell 254, and third clamshell 256 and/or on a inside surface (not shown) of one of front panel 260 and second panel 262 of support card 250. Then, at 310, inside surfaces of front panel 260 and rear panel 262 are aligned with and coupled to one another using adhesive or other suitable method. When assembled, in one embodiment, the resultant transaction product assembly 10 is formed similar to that described above and illustrated in FIGS. 1-3. Upon final assembly, transaction product assembly 10 is ready for shipment to and display within a retail store or similar setting for viewing by potential consumers.

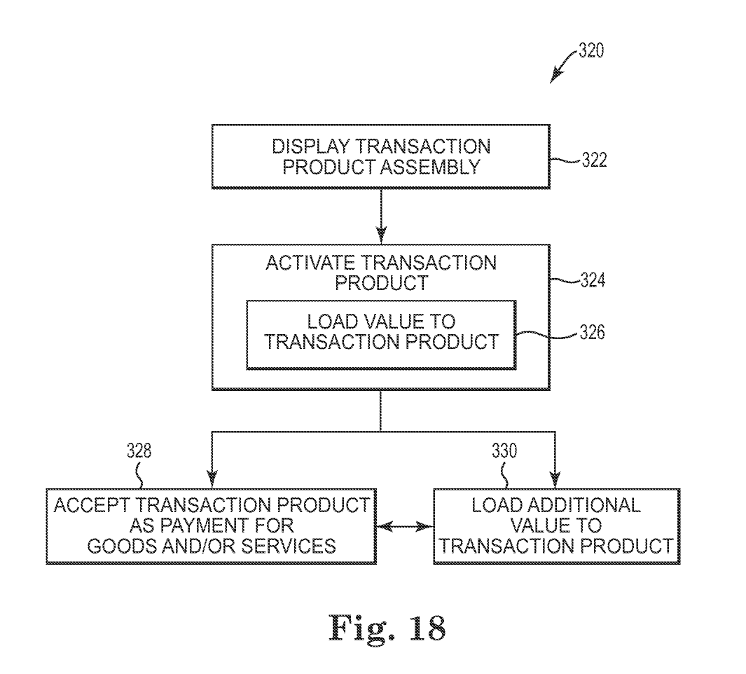

FIG. 18 is a flow chart illustrating one embodiment of a method 320 of encouraging purchase and facilitating use of transaction product assembly 10 by consumers and/or recipients. At 322, transaction product assembly 10 is placed on or hung from a rack, shelf, or other similar device to display transaction product assembly 10 for sale to potential consumers. In one embodiment, a depiction of transaction product assembly 10 is additionally or alternatively placed on a website for viewing and purchase by potential consumers.

At 324, a consumer who has decided to purchase transaction product assembly 10 presents transaction product assembly 10 to a retail store employee, retail store kiosk, remote terminal, or other person or device to scan account identifier 20 using a point-of-sale terminal or other machine to access an account or record linked to account identifier 20. In particular, account identifier 20 is scanned or otherwise accessed, for example through activation aperture 279 of support card 250 to activate transaction product assembly 10, more particularly, transaction product 12 and the account or record linked thereto. Upon accessing the account or record, then, at 326, value is added to the account or record in the form of monetary value, points, minutes, etc. Thus, transaction product 12 is activated and loaded.

In one example, a predetermined value is associated with transaction product 12 (i.e., associated with the account or record linked to transaction product 12 via account identifier 20) prior to activation and display, but such predetermined value is not initially available for use toward the purchase or use of goods and/or services. In such an embodiment, at 324, transaction product 12 is activated to permit subsequent access to the predetermined value (e.g., subsequent loading on and debiting from the account or record) and no additional value is added during activation such that operation 326 may be eliminated.

Once transaction product 12 is activated and loaded, transaction product 12 can be used by the consumer or any other bearer of transaction product 12 to purchase goods and/or services at the affiliated retail setting (e.g., a retail store or website) or can be used in exchange for calling minutes, etc. In one embodiment, where transaction product 12 is displayed on a website at 322, then, at 324, transaction product 12 may be activated in any suitable method and may not require the physical scanning of account identifier 20 to be activated or to otherwise access the associated account or record such as at 326.

In one example, at 328, the retail store or other affiliated retail setting or website accepts transaction product 12 as payment toward the purchase of goods and/or services made by the current bearer of transaction product 12. In particular, the value currently loaded on transaction product 12 (i.e., stored or recorded in the account or record linked to account identifier 20) is applied toward the purchase of goods and/or services. At 330, additional value is optionally loaded on transaction product 12 at a point-of-sale terminal, kiosk or other area of the retail store or related setting. Upon accepting transaction product 12 as payment at 328, the retail store or related setting can subsequently perform either operation 328 or operation 330 as requested by a current bearer of transaction product 12. Similarly, upon loading additional value on transaction product 12 at 330, the retail store or related setting can subsequently perform either operation 330 again or operation 328. In one example, the ability to accept transaction product 12 as payment for goods and/or services is limited by whether the account or record associated with transaction product 12 has any value stored or recorded therein at the time of attempted redemption.

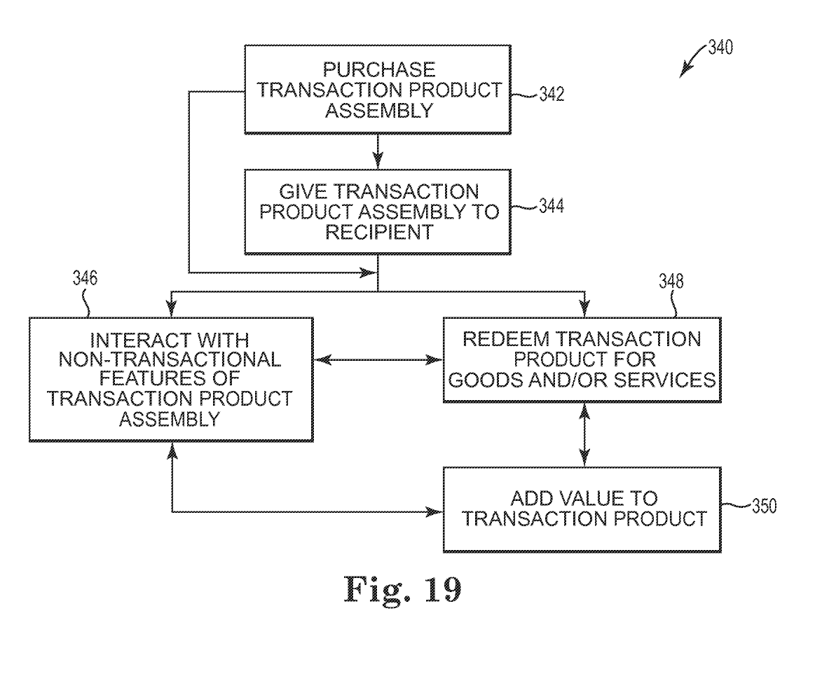

FIG. 19 is a flow chart illustrating one embodiment of a method 340 of using transaction product assembly 10 (e.g., FIGS. 1-10). At 342, a potential consumer of transaction product assembly 10, which is displayed in a retail store or viewed on a website, decides to and does purchase transaction product assembly 10 from the retail store or website. Notably, as used herein the term “purchasing” does not require a value be paid for transaction card assembly 10 rather that card be properly activated for access to the monetary value in the account or record linked thereto. Upon purchasing transaction product assembly 10, a retail store employee, a retail store kiosk or other person or device scans account identifier 20 (FIGS. 2 and 6) through activation aperture 270 of support card 250 or otherwise reads or accesses account identifier 20. Upon accessing account identifier 20, the account or record linked to account identifier 20 is accessed and activated to load value onto transaction product 12 (i.e., load value to the account or record associated with transaction product 12). In one embodiment, such as where transaction product assembly 10 is purchased at 342 via a website, actual scanning or other mechanical detection of account identifier 20 may be eliminated.

At 344, the consumer optionally gives transaction product assembly 10 to a recipient, such as a graduate, relative, friend, expectant parents, one having a recent or impending birthday, a couple having a recent or impending anniversary, etc. In one embodiment, a plurality of transaction product assembly 10 are purchased and given to party goers, such as at a birthday party, etc. as party favors or gifts. As an alternative, the consumer can keep transaction product assembly 10 for his or her own use thereby eliminating operation 344.

At 346, the consumer, recipient, or other current bearer of transaction product assembly 10 interacts with the non-transactional features thereof for amusement. More specifically, the bearer of transaction product assembly 10 removes transaction product 12 and auxiliary vehicle 14 from packaging, actuates, and observes resultant movement of auxiliary vehicle 14 such as the actuation and movement described above. Such use amuses the bearer and any other observers of transaction product 12 and auxiliary vehicle 14.

At 348, the consumer or recipient redeems transaction product 12 for goods and/or services from the retail store or website. At 350, the consumer or recipient of transaction product 12 optionally adds monetary or similar value to transaction product 12, more particularly, to the account or record associated with account identifier 20 included therewith, at the retail store or over the Internet (i.e., via the website). Upon interacting with the non-transaction feature of transaction product assembly 10 at 346, redeeming transaction product 12 at 348 or adding value to transaction product 12 at 350, the consumer or recipient of transaction product assembly 10 subsequently can perform any of operations 346, 348, or 350 as desired. In one embodiment, the ability of the consumer or recipient to repeat redeeming transaction product 12 at 348 is limited by whether the account or record linked with transaction product 12 has any remaining value stored or recorded therein at the time of attempted redemption.

Although described above as occurring at a single retail store or website, in one embodiment, purchasing transaction product assembly 10 at 342, redeeming transaction product 12 at 348, and adding value to transaction product 12 at 350, can each be performed at any one of a number of stores adapted to accept transaction product 12 or over the Internet. In one example, a number of stores are each part of a chain or are similarly branded stores. In one example, a number of stores include at least one website and/or at least one conventional brick and mortar store.

Transaction cards and products come in many forms, according to embodiments of the invention. Stored-value cards, like other transaction products, can be “re-charged” or “re-loaded” at the direction of the original consumer, the gift recipient or a third party. The term “loading on” or “loaded on” herein should be interpreted to include adding to the balance of an account or record associated with a transaction card. The balance associated with the transaction card declines as the card is used, encouraging repeat visits or use. The card remains in the user's purse or wallet, serving as an advertisement or a reminder to revisit the associated merchant. Stored-value cards according to embodiments of the invention provide a number of advantages to both the consumer and the merchant. Other stored-value cards and transaction products according to embodiments of the invention include loyalty cards, merchandise return cards, electronic gift certificates, calling cards, employee cards, frequency cards, prepaid cards and other types of cards associated with or representing purchasing power, monetary value, etc.

Although the invention has been described with respect to particular embodiments, such embodiments are meant for illustrative purposes only and should not be considered to limit the invention. Various alternatives and changes will be apparent to those of ordinary skill in the art. Other modifications within the scope of the invention and its various embodiments will be apparent to those of skill in the art.

What is claimed is:

1. A transaction product assembly comprising:
a transaction product including an account identifier fixedly connected thereto, wherein the account identifier links the transaction product to an account having an associated monetary value, and the account identifier is machine readable by a point-of-sale terminal, the transaction product further comprising:
a transmitting electrical assembly configured to output a radio frequency signal, and
at least one control button configured to interact with the transmitting electrical assembly in a manner causing the transmitting electrical assembly to output the radio frequency signal; and
a mechanical article including at least one movable member, a receiving electrical assembly, and a motor, wherein the receiving electrical assembly is configured to remotely receive the radio frequency signal output from the transmitting electrical assembly and to activate the motor to induce movement of the at least one movable member relative to a remainder of the mechanical article in a manner consistent with the radio frequency signal.

2. The transaction product assembly of claim 1, wherein the account identifier is a bar code.

3. The transaction product assembly of claim 1, wherein the account identifier includes at least one of a bar code, a magnetic strip, a smart chip, and a radio frequency identification (RFID) device.

4. The transaction product assembly of claim 1, wherein the transaction product includes a housing substantially enclosing the transmitting electrical assembly.

5. The transaction product assembly of claim 4, wherein the housing includes a first housing member and a second housing member coupled to one another to substantially enclose the transmitting electrical assembly in a cavity collectively defined by the first housing member and the second housing member.

6. The transaction product assembly of claim 5, wherein:
the second housing member defines a recess along an outer surface thereof,
the housing includes a third housing member,
the third housing member is formed separately from each of the first housing member and the second housing member, and
the third housing member is slidably received within the recess defined by the second housing member.

7. The transaction product assembly of claim 6, wherein:
the transmitting electrical assembly includes a battery,
the third housing member slides between a first position covering the battery and a second position exposing the battery,
the third housing member includes an outside surface opposite the second housing member, and
the account identifier is rigidly secured to the outside surface of the third housing member.

8. The transaction product assembly of claim 4, wherein:
the transmitting electrical assembly includes an antenna to facilitate output of the radio frequency signal, and
the antenna is configured to retract from a first position substantially extending out of the housing to a second position substantially enclosed within the housing.

9. The transaction product assembly of claim 4, wherein:
the transaction product assembly is provided in a theme,
the housing of the transaction product is provided as a first item in accordance with the theme, and
the mechanical article is provided as a second item in accordance with the theme.

10. The transaction product assembly of claim 9, wherein the first item is a piece of cheese, and the second item includes a mouse.

11. The transaction product assembly of claim 4, wherein:
the housing defines a battery chamber substantially enclosed within the housing,
the housing includes a door configured to transition between a first position covering the battery chamber and a second position leaving the battery chamber exposed, and the door remains coupled to a remainder of the housing while in each of the first position and the second position, and
the transaction product further comprises one or more batteries removably positioned within the battery chamber to power the transmitting electrical assembly.

12. The transaction product assembly of claim 1, wherein:
the mechanical article is a vehicle,
the at least one movable member includes at least one wheel configured to interact with a support surface such that rotation of the at least one wheel causes the mechanical article to move at least one of forward and backward on the support surface, and
the at least one control button includes one or more control buttons configured to dictate whether the mechanical article moves forward or backward.

13. The transaction product assembly of claim 1, further comprising a package for enclosing the transaction product and the mechanical article for retail sale, wherein:
the package defines a first chamber and a second chamber spaced from the first chamber,
the transaction product is enclosed within the first chamber, and
the mechanical article is enclosed within the second chamber.

14. The transaction product assembly of claim 13, wherein:
the package includes a support card supporting the first chamber and the second chamber,
the support card is substantially planar and defines a front side, a rear side opposite the front side, and an aperture extending through the support card from the front side to the rear side,
the first chamber is defined entirely on the front side of the support card, and
the second chamber extends on both the front side and the rear side of the support card and through the aperture defined through the support card.

15. The transaction product assembly of claim 13, wherein the package includes an activation aperture exposing the account identifier on the transaction product while the transaction product is enclosed within the first chamber.

16. A stored-value card comprising:
an enclosure including an outside surface and an interior chamber;
an account identifier securely affixed to the outside surface of the enclosure, wherein the account identifier links the stored-value card to an account having an associated monetary value, and the account identifier is machine readable by a point-of-sale terminal,
one or more switches extending from within the interior chamber to outside the enclosure; and
an electrical assembly substantially entirely maintained within the interior chamber, wherein:
the electrical assembly is placed in communication with the one or more switches such that a user controls the electrical assembly via user interaction with the one or more switches, and
the electrical assembly outputs instructional signals to a remote receptor based on the user interaction with the one or more switches.

17. The stored-value card of claim 16, in combination with an auxiliary vehicle including at least one movable member, a receiving electrical assembly, and a motor, wherein the receiving electrical assembly is configured to wirelessly and remotely receive the instructional signals output from the electrical assembly of the stored-value card and to activate the motor to induce movement of the at least one movable member relative to a remainder of the auxiliary vehicle based on the instructional signals.

18. The combination of claim 17, wherein:
the at least one movable member of the auxiliary vehicle includes at least one wheel configured to interact with a support surface such that rotation of the at least one wheel causes the auxiliary vehicle to move one of forward, backward, and to the side on the support surface,
upon user interaction with the one or more switches, the electrical assembly of the stored-value card transmits instructional signals to the auxiliary vehicle to move forward, and
in response to receipt of the instructional signals, the receiving electrical assembly is configured to communicate with the motor to cause forward movement of the auxiliary vehicle along the support surface.

19. The combination of claim 17, wherein:
the enclosure is provided as a first item in accordance with a theme; and
the auxiliary vehicle is provided as a second item in accordance with the theme.

20. The combination of claim 17, in further combination with a package for enclosing the stored-value card and the auxiliary vehicle for retail sale, wherein:
the package defines:
a first chamber,
a second chamber spaced from the first chamber, and
a substantially planar backer supporting each of the first chamber and the second chamber and defining a front side and a rear side opposite the front side,
the first chamber is defined substantially entirely on the front side of the substantially planar backer,
the second chamber extends on both the front side and the rear side of the substantially planar backer,
the stored-value card is enclosed within the first chamber; and
the auxiliary vehicle is enclosed within the second chamber.

21. The stored-value card of claim 16, wherein the enclosure includes a first enclosure member and a second enclosure member coupled to one another to substantially enclose the electrical assembly in the interior chamber collectively defined by the first enclosure member and the second enclosure member.

22. The stored-value card of claim 21, wherein:
the enclosure includes a third enclosure member separate from each of the first enclosure member and the second enclosure member,
the third enclosure member is slidably coupled with the second housing member and is configured to slide between a first position and a second position,
the third enclosure member remains coupled with the second enclosure member while in the first position, while in the second position, and while transitioning between the first position and the second position,
the third enclosure member includes an outer surface opposite the second enclosure member, and
the account identifier is rigidly secured to the outer surface of the third enclosure member.

23. A transaction product assembly including:
a mechanical vehicle having at least one moving part, the mechanical vehicle including:
means for receiving a radio frequency instructional signal, and
means for effectuating movement of the at least one moving part in a manner dictated by the radio frequency instructional signal; and
a transaction product including:
means for generating and transmitting the radio frequency instructional signal to the means for receiving,
means for user interaction with the transaction product to initiate the means for generating and transmitting the radio frequency instructional signal to generate and transmit the radio frequency signal to the means for receiving,
means for substantially enclosing the means for generating and transmitting the radio frequency instructional signal; and
machine readable means for securely linking at least one of the means for substantially enclosing and the mechanical vehicle with an account stored in a remote database, the account including a monetary value available for use toward a purchase of one or more of goods and services such that the at least one of the means for substantially enclosing and the mechanical article is configured for use toward the purchase of the one or more of goods and services.

24. A method of encouraging purchase and facilitating use of a stored-value product assembly, the method comprising:
displaying the stored-value product assembly to a plurality of potential consumers, wherein:
the stored-value product assembly includes a controller and a mechanical article,
the controller includes user interface buttons and a first electrical assembly,
the first electrical assembly is configured to output a radio signal based on user input to the controller received via the user interface buttons,
the mechanical article includes a second electrical assembly, a motor, and at least one moveable part,
the second electrical assembly is configured to remotely and wirelessly receive the radio signal from the controller and to instruct the motor to effectuate movement of the at least one moveable part in a manner dictated by the radio signal received from the controller, and
the controller is linked to an account having a value available toward a purchase of one or more of goods and services via an account identifier securely coupled with the controller;
promoting the mechanical article and an ability of the controller to remotely control movement of the mechanical article to the plurality of potential consumers;
accessing the account linked to the controller by reading the account identifier from the controller; and
activating the account to ready the value in the account for use toward a purchase of one or more of goods and services when a point-of-sale device accesses the account linked to the controller by reading the account identifier from the controller.

25. The method of claim 24, further comprising loading additional value to the account.
